(19) United States
(12) Patent Application Publication
(10) Pub. No.: US 2002/0145834 A1
(43) Pub. Date: Oct. 10, 2002

(54) THIN FILM MAGNETORESISTIVE HEAD WITH HEAT TREATED OR OXYGEN TREATED INSULATIVE FILM

(76) Inventors: TORU INOUE, TOKYO (JP); KOICHI TERUNUMA, TOKYO (JP)

Correspondence Address: OLIFF & BERRIDGE, PLC, P.O. BOX 19928, ALEXANDRIA, VA, 22320, US

(21) Appl. No.: 09/411,321

(22) Filed: Oct. 4, 1999

(30) Foreign Application Priority Data
Oct. 8, 1998 (JP) 10-286178

(51) Int. Cl. G11B 5/39

(52) U.S. Cl. 360/320; 29/603.08

(57) ABSTRACT

Each of the first and second shield gap films has a highly insulative film made of aluminum oxide. The highly insulative film has the insulating properties improved by heating. The insulating properties may be improved by heating after deposition or by depositing while heating. This heating allows the highly insulative film to have a reduced pinhole density and an increased dielectric breakdown field. Therefore, the insulating properties can be ensured even if a shield gap length is reduced, and thus it is possible to adapt to an increase in a recording density of a recording medium. The highly insulative film may have the insulating properties improved by exposing the film surface to an oxygen-plasma-containing atmosphere or oxygen-ion-containing atmosphere after deposition.

### BACKGROUND OF THE INVENTION

1. Field of the Invention

The invention relates to a thin film device including an insulating film, a thin film magnetic head having a pair of shield gap films made of insulator which a magnetoresistive element is sandwiched in between, a magnetoresistive element partly having the insulating film, and a method of manufacturing the same.

2. Description of the Related Art

Currently, a composite thin film magnetic head is widely used as a thin film magnetic head. The composite thin film magnetic head has a laminated structure including a recording head having an inductive-type magnetic transducer for writing and a reproducing head having a magnetoresistive (hereinafter also referred to as MR) element for reading. For example, the reproducing head having an MR element sandwiched by a pair of shield films with a pair of shield gap films in between is popular. Here, each shield gap film is used for providing electrical insulation between the MR element and each shield film. A total sum of a thickness of each shield gap film and a thickness of the MR element is equal to a shield gap length. Each shield gap film is generally made of aluminum oxide (Al₂O₃) formed by sputtering.

By the way, such a thin film magnetic head has the shorter shield gap length in accordance with a recent increase in a recording density of a hard disk device. For example, the shield gap length is about 0.12 μm for a surface recording density of 10 gigabits per square inch. The shield gap length is about 0.09 μm for a surface recording density of 20 gigabits per square inch. This also results in a reduction in the thickness of each shield gap. The thickness of the shield gap is about 40 nm for a surface recording density of 10 gigabits per square inch. The thickness of the shield gap is about 20 nm for a surface recording density of 20 gigabits per square inch.

However, a problem has heretofore existed. Less film thickness deteriorates electrical insulating properties because each shield gap film is formed by sputtering. This problem is caused by two disadvantages: one disadvantage is that less film thickness results in an insufficient dielectric breakdown field of an aluminum oxide film itself; and the other is that less film thickness results in the increase in a pinhole density of the film. Consequently, less film thickness has been heretofore unable to sufficiently ensure the electrical insulation between each shield film and the MR element, thereby reducing manufacturing yield.

A technique of forming each shield gap film composed of aluminum oxide having excellent insulating properties by applying thermal oxidation to metal aluminum is disclosed in Japanese Patent Application Laid-open No. 9-198619. However, this technique has a problem. Since the aluminum oxide film is formed by oxidizing a metal aluminum film, a volume of the film varies and thus it is difficult to control the film thickness. That is, it is difficult to form the thin shield gap film having a film thickness of 50 nm or less with high precision.

### SUMMARY OF THE INVENTION

The invention is made in view of the above problems. It is an object of the invention to provide a thin film device, a thin film magnetic head, a magnetoresistive element and a method of manufacturing the same, which can reduce a film thickness of an insulating film by improving insulating properties.

A thin film device of the invention includes an insulating film. In the thin film device, the insulating film has a highly insulative film containing aluminum oxide and having insulating properties improved by heating.

In the thin film device of the invention, the insulating properties are improved by heating. Thus, high insulating properties can be obtained even if a film thickness is reduced.

In the thin film device of the invention, the insulating properties may be improved by heating after deposition. Moreover, the insulating properties may be improved by depositing while heating. Moreover, the insulating properties may be improved by both of these processes. Moreover, for example, preferably, a heating temperature is within a range of from 150° C. to 450° C. inclusive. More preferably, the heating temperature is within a range of from 200° C. to 350° C. inclusive. Most preferably, the heating temperature is within a range of from 250° C. to 300° C. inclusive.

Furthermore, in the thin film device of the invention, the insulating film may further have a highly thermally conductive insulating film containing at least one of aluminum nitride, boron nitride, silicon nitride, silicon carbide and carbon nitride. In this case, high thermal conductivity as well as the high insulating properties can be obtained.

Another thin film device of the invention includes an insulating film. In another thin film device, the insulating film has a highly insulative film containing aluminum oxide and having insulating properties improved by treatment in an oxygen-plasma-containing atmosphere or oxygen-ion-containing atmosphere.

In another thin film device of the invention, the insulating properties are improved by the treatment in the oxygen-plasma-containing atmosphere or oxygen-ion-containing atmosphere. Thus, the high insulating properties can be obtained even if the film thickness is reduced.

In another thin film device of the invention, the insulating film may further have a highly thermally conductive insulating film containing at least one of aluminum nitride, boron nitride, silicon nitride, silicon carbide and carbon nitride. In this case, the high thermal conductivity as well as the high insulating properties can be obtained.

A thin film magnetic head of the invention includes a magnetoresistive element, first and second shield films located so as to face each other across the magnetoresistive element and shielding the magnetoresistive element, a first shield gap film located between the first shield film and the magnetoresistive element, and a second shield gap film located between the second shield film and the magnetoresistive element.

In the thin film magnetic head, at least either the first or second shield gap film has a highly insulative film containing aluminum oxide and having insulating properties improved by heating.

In the thin film magnetic head of the invention, information is read by passing a sense current through the magnetoresistive element. At this time, insulation between the first and second shield films and the magnetoresistive element is ensured by the first and second shield gap films. In this case, at least either the first or second shield gap film has the highly insulative film whose insulating properties are improved by heating. Thus, the high insulating properties are ensured even if the film thickness is reduced.

In the thin film magnetic head of the invention, the insulating properties may be improved by heating after deposition. Moreover, the insulating properties may be improved by depositing while heating. Moreover, the insulating properties may be improved by both of these processes. Moreover, for example, preferably, the heating temperature is within a range of from 150° C. to 450° C. inclusive. More preferably, the heating temperature is within a range of from 200° C. to 350° C. inclusive. Most preferably, the heating temperature is within a range of from 250° C. to 300° C. inclusive.

Furthermore, in the thin film magnetic head of the invention, at least either the first or second shield gap film may further have a highly thermally conductive insulating film containing at least one of aluminum nitride, boron nitride, silicon nitride, silicon carbide and carbon nitride. In this case, the high thermal conductivity as well as the high insulating properties can be obtained.

Additionally, in the thin film magnetic head of the invention, at least either the first or second shield gap film may be 50 nm or less in thickness. Also in this case, the high insulating properties can be obtained.

Another thin film magnetic head of the invention includes a magnetoresistive element, first and second shield films located so as to face each other across the magnetoresistive element and shielding the magnetoresistive element, a first shield gap film located between the first shield film and the magnetoresistive element, and a second shield gap film located between the second shield film and the magnetoresistive element. In another thin film magnetic head, at least either the first or second shield gap film has a highly insulative film containing aluminum oxide and having insulating properties improved by treatment in an oxygen-plasma-containing atmosphere or oxygen-ion-containing atmosphere.

In another thin film magnetic head of the invention, the information is read by passing the sense current through the magnetoresistive element. At this time, the insulation between the first and second shield films and the magnetoresistive element is ensured by the first and second shield gap films. In this case, at least either the first or second shield gap film has the highly insulative film whose insulating properties are improved by the treatment in the oxygen-plasma-containing atmosphere or oxygen-ion-containing atmosphere. Thus, the high insulating properties are ensured even if the film thickness is reduced.

In another thin film magnetic head of the invention, at least either the first or second shield gap film may further have a highly thermally conductive insulating film containing at least one of aluminum nitride, boron nitride, silicon nitride, silicon carbide and carbon nitride. In this case, the high thermal conductivity as well as the high insulating properties can be obtained.

Moreover, in another thin film magnetic head of the invention, at least either the first or second shield gap film may be 50 nm or less in thickness. Also in this case, the high insulating properties can be obtained.

A magnetoresistive element of the invention at least partly has an insulating film. In the magnetoresistive element, the insulating film has a highly insulative film containing aluminum oxide and having insulating properties improved by heating.

In the magnetoresistive element of the invention, the insulating properties of the insulating film are improved by heating. Thus, the insulating properties are increased even if the film thickness is reduced.

In the magnetoresistive element of the invention, the insulating properties may be improved by heating after deposition. Moreover, the insulating properties may be improved by depositing while heating. Moreover, the insulating properties may be improved by both of these processes. Moreover, the insulating film may further have a highly thermally conductive insulating film containing at least one of aluminum nitride, boron nitride, silicon nitride, silicon carbide and carbon nitride. In this case, the high thermal conductivity as well as the high insulating properties can be obtained.

Another magnetoresistive element of the invention at least partly has an insulating film. In another magnetoresistive element, the insulating film has a highly insulative film containing aluminum oxide and having insulating properties improved by treatment in an oxygen-plasma-containing atmosphere or oxygen-ion-containing atmosphere.

In another magnetoresistive element of the invention, the insulating properties of the insulating film are improved by the treatment in the oxygen-plasma-containing atmosphere or oxygen-ion-containing atmosphere. Thus, the insulating properties are increased even if the film thickness is reduced.

In another magnetoresistive element of the invention, the insulating film may further have a highly thermally conductive insulating film containing at least one of aluminum nitride, boron nitride, silicon nitride, silicon carbide and carbon nitride. In this case, the high thermal conductivity as well as the high insulating properties can be obtained.

A method of manufacturing a thin film device of the invention is a method of manufacturing a thin film device including an insulating film. In the method of manufacturing a thin film device, at least part of the insulating film is formed by an aluminum-oxide-containing highly insulative film whose insulating properties are improved by heating.

In the method of manufacturing a thin film device of the invention, at least part of the insulating film is formed by the highly insulative film whose insulating properties are improved by heating.

In the method of manufacturing a thin film device of the invention, the highly insulative film having the improved insulating properties may be formed by heating after deposition. The highly insulative film having the improved insulating properties may be formed by depositing while heating. The highly insulative film having the improved insulating properties may be formed by both of these processes.

Moreover, for example, preferably, heating takes place within a range of from 150° C. to 450° C. inclusive. More preferably, heating takes place within a range of from 200° C. to 350° C. inclusive. Most preferably, heating takes place within a range of from 250° C. to 300° C. inclusive.

Furthermore, in the method of manufacturing a thin film device of the invention, a part of the insulating film may be further formed by a highly thermally conductive insulating film containing at least one of aluminum nitride, boron nitride, silicon nitride, silicon carbide and carbon nitride.

Another method of manufacturing a thin film device of the invention is a method of manufacturing a thin film device including an insulating film. In another method of manufacturing a thin film device, at least part of the insulating film is formed by an aluminum-oxide-containing highly insulative film whose insulating properties are improved by treatment in an oxygen-plasma-containing atmosphere or oxygen-ion-containing atmosphere.

In another method of manufacturing a thin film device of the invention, at least part of the insulating film is formed by the highly insulative film whose insulating properties are improved by the treatment in the oxygen-plasma-containing atmosphere or oxygen-ion-containing atmosphere.

In another method of manufacturing a thin film device of the invention, a part of the insulating film may be further formed by a highly thermally conductive insulating film containing at least one of aluminum nitride, boron nitride, silicon nitride, silicon carbide and carbon nitride.

A method of manufacturing a thin film magnetic head of the invention includes the step of laminating in order a first shield film, a first shield gap film, a magnetoresistive element, a second shield gap film and a second shield film. In the method of manufacturing a thin film magnetic head, at least part of at least either the first or second shield gap film is formed by an aluminum-oxide-containing highly insulative film whose insulating properties are improved by heating.

In the method of manufacturing a thin film magnetic head of the invention, at least part of at least either the first or second shield gap film is formed by the highly insulative film whose insulating properties are improved by heating.

In the method of manufacturing a thin film magnetic head of the invention, the highly insulative film having the improved insulating properties may be formed by heating after deposition. The highly insulative film having the improved insulating properties may be formed by depositing while heating. The highly insulative film having the improved insulating properties may be formed by both of these processes.

Moreover, for example, preferably, heating takes place within a range of from 150° C. to 450° C. inclusive. More preferably, heating takes place within a range of from 200° C. to 350° C. inclusive. Most preferably, heating takes place within a range of from 250° C. to 300° C. inclusive.

Furthermore, in the method of manufacturing a thin film magnetic head of the invention, a part of the insulating film may be further formed by a highly thermally conductive insulating film containing at least one of aluminum nitride, boron nitride, silicon nitride, silicon carbide and carbon nitride.

Another method of manufacturing a thin film magnetic head of the invention includes the step of laminating in order a first shield film, a first shield gap film, a magnetoresistive element, a second shield gap film and a second shield film. In another method of manufacturing a thin film magnetic head, at least part of at least either the first or second shield gap film is formed by an aluminum-oxide-containing highly insulative film whose insulating properties are improved by treatment in an oxygen-plasma-containing atmosphere or oxygen-ion-containing atmosphere.

In another method of manufacturing a thin film magnetic head of the invention, at least part of at least either the first or second shield gap film is formed by the highly insulative film whose insulating properties are improved by the treatment in the oxygen-plasma-containing atmosphere or oxygen-ion-containing atmosphere.

In another method of manufacturing a thin film magnetic head of the invention, a part of the insulating film may be further formed by a highly thermally conductive insulating film containing at least one of aluminum nitride, boron nitride, silicon nitride, silicon carbide and carbon nitride.

A method of manufacturing a magnetoresistive element of the invention is a method of manufacturing a magnetoresistive element at least partly having an insulating film. In the method of manufacturing a magnetoresistive element, at least part of the insulating film is formed by an aluminum-oxide-containing highly insulative film whose insulating properties are improved by heating.

In the method of manufacturing a magnetoresistive element of the invention, at least part of the insulating film is formed by the highly insulative film whose insulating properties are improved by heating.

In the ethod of manufacturing a magnetoresistive element of the invention, the highly insulative film having the improved insulating properties may be formed by heating after deposition. The highly insulative film having the improved insulating properties may be formed by depositing while heating. The highly insulative film having the improved insulating properties may be formed by both of these processes.

Moreover, in the method of manufacturing a magnetoresistive element of the invention, a part of the insulating film may be further formed by a highly thermally conductive insulating film containing at least one of aluminum nitride, boron nitride, silicon nitride, silicon carbide and carbon nitride.

Another method of manufacturing a magnetoresistive element of the invention is a method of manufacturing a magnetoresistive element at least partly having an insulating film. In another method of manufacturing a magnetoresistive element, at least part of the insulating film is formed by an aluminum-oxide-containing highly insulative film whose insulating properties are improved by treatment in an oxygen-plasma-containing atmosphere or oxygen-ion-containing atmosphere.

In another method of manufacturing a magnetoresistive element of the invention, at least part of the insulating film is formed by the highly insulative film whose insulating properties are improved by the treatment in the oxygen-plasma-containing atmosphere or oxygen-ion-containing atmosphere.

In another method of manufacturing a magnetoresistive element of the invention, a part of the insulating film may be further formed by a highly thermally conductive insulating film containing at least one of aluminum nitride, boron nitride, silicon nitride, silicon carbide and carbon nitride.

Other and further objects, features and advantages of the invention will appear more fully from the following description.

### BRIEF DESCRIPTION OF THE DRAWINGS

FIGS. 1A and 1B are cross sectional views of a constitution of a thin film magnetic head according to one embodiment of the invention;

FIG. 2 is a plan view of the constitution of the thin film magnetic head shown in FIGS. 1A and 1B;

FIGS. 3A and 3B are cross sectional views of one process of manufacturing the thin film magnetic head shown in FIGS. 1A and 1B;

FIGS. 4A and 4B are cross sectional views of the manufacturing process following the process of FIGS. 3A and 3B;

FIGS. 5A and 5B are cross sectional views of the manufacturing process following the process of FIGS. 4A and 4B;

FIGS. 6A and 6B are cross sectional views of the manufacturing process following the process of FIGS. 5A and 5B;

FIGS. 7A and 7B are cross sectional views of the manufacturing process following the process of FIGS. 6A and 6B;

FIGS. 8A and 8B are cross sectional views of the manufacturing process following the process of FIGS. 7A and 7B;

FIGS. 9A and 9B are cross sectional views of the manufacturing process following the process of FIGS. 8A and 8B;

FIG. 10 is a property graph of a relationship between an electric field and resistivity for describing an effect of the thin film magnetic head according to a first embodiment of the invention; and

FIG. 11 is a property graph of the relationship between the electric field and the resistivity for describing the effect of the thin film magnetic head according to a second embodiment of the invention.

### DETAILED DESCRIPTION OF THE PREFERRED EMBODIMENTS

Embodiments of the invention will be described in detail below with reference to the accompanying drawings.

[First Embodiment]

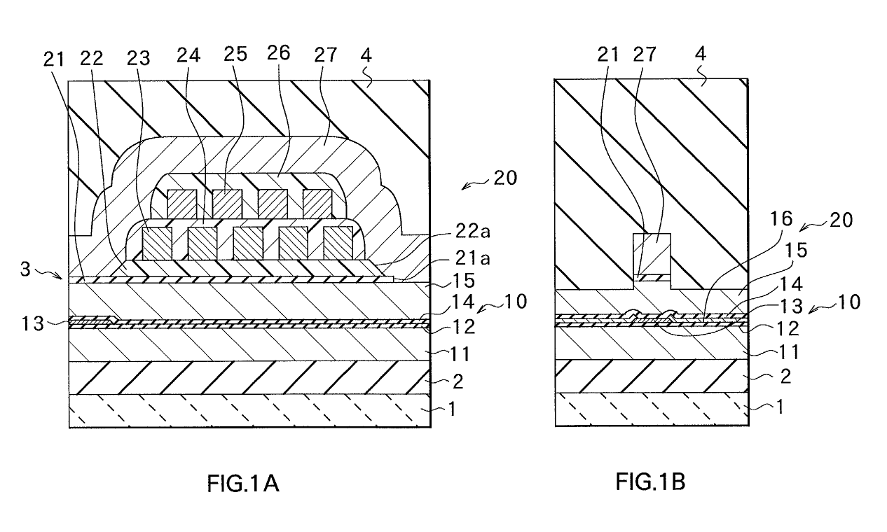

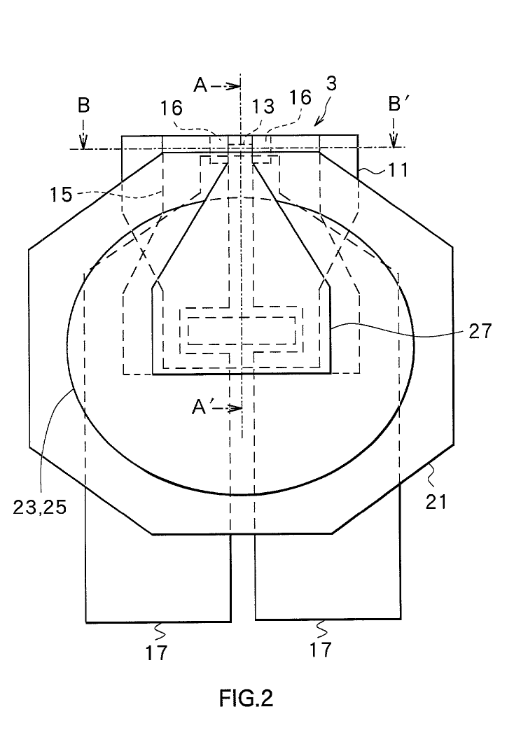

FIGS. 1A and 1B show a cross section of a thin film magnetic head according to a first embodiment of the invention. FIG. 2 shows a planar structure of the thin film magnetic head shown in FIGS. 1A and 1B. FIG. 1A shows a cross section taken on line A-A′ of FIG. 2 perpendicular to an air bearing surface (a surface closer to a magnetic recording medium not shown). FIG. 1B shows a cross section taken on line B-B′ of FIG. 2 parallel to the air bearing surface of a magnetic pole portion.

The thin film magnetic head has a laminated structure including a reproducing head 10 for reading and a recording head 20 for writing, these heads being laminated on one surface of a substrate 1 (the upper surface thereof in FIGS. 1A and 1B) through an insulating film 2. The substrate 1 is made of a composite material containing aluminum oxide and titanium carbide (TiC), for example. For example, the insulating film 2 has a lamination thickness (hereinafter referred to as a thickness) of about 1-10 μm, and the insulating film 2 is made of an insulating material such as aluminum oxide.

The reproducing head 10 has the laminated structure including a first shield film 11, a first shield gap film 12, an MR element 13, a second shield gap film 14 and a second shield film 15, these being laminated in order on the insulating film 2. The first and second shield films 11 and 15 are used for magnetically shielding the MR element 13. The films 11 and 15 are located so that they may face each other across the MR element 13. For example, the first shield film 11 is about 0.5-3 μm in thickness and is made of a magnetic material such as an alloy (NiFe alloy) of nickel (Ni) and iron (Fe).

For example, the second shield film 15 is about 3 μm in thickness and is made of the magnetic material such as the NiFe alloy or nitride ferrous (FeN). Although the second shield film 15 may have a single-layered structure, the film 15 may have the laminated structure including a plurality of films made of different materials. The second shield film 15 also functions as a first magnetic pole for the recording head 20.

The first and second shield gap films 12 and 14 are the insulating films for providing electrical insulation between the first and second shield films 11 and 15 and the MR element 13. For example, each of the first and second shield gap films 12 and 14 is about 20-40 nm in thickness and is made of an aluminum-oxide-containing highly insulative film whose insulating properties are improved by heating. The highly insulative film has a reduced pinhole density and an increased dielectric breakdown field as the result of heating. The highly insulative film can therefore ensure high insulating properties, even if a film thickness is as thin as 50 nm or less.

The highly insulative film may be also the film whose insulating properties are improved by heating after deposition. The highly insulative film may be also the film whose insulating properties are improved by depositing while heating. The highly insulative film may be also the film whose insulating properties are improved by both of these processes. Preferably, the highly insulative film is the film heated within a range of from 150° C. to 450° C. inclusive. More preferably, the highly insulative film is the film heated within a range of from 200° C. to 350° C. inclusive. Most preferably, the highly insulative film is the film heated within a range of from 250° C. to 300° C. inclusive. Such a temperature range is set because a low heating temperature cannot obtain the high insulating properties and a high heating temperature causes micro-cracking due to a difference in thermal expansion.

The MR element 13 is used for reading information written on the magnetic recording medium not shown. The MR element 13 is located closer to an air bearing surface 3. MR elements for the MR element 13 include an AMR element utilizing an anisotropic magnetoresistive (hereinafter referred to as AMR) effect and a GMR element utilizing a giant magnetoresistive (hereinafter referred to as GMR) effect. The MR element 13 may be composed of either element.

For example, the AMR element includes an AMR effect film having the AMR effect. The AMR effect film has the single-layered structure composed of a magnetic substance exhibiting an MR effect, for instance. The GMR element includes a GMR film having the GMR effect. The GMR film has a multi-layered structure including a combination of a plurality of films, for example. A layer structure of the GMR film is determined in accordance with a mechanism which produces the GMR effect. For example, GMR films include a superlattice GMR film, a spin valve film and a granular film. A reproducing output of the GMR element can be about 3 to 5 times greater than that of the AMR element, because the GMR film exhibits a greater change in resistance under the same external magnetic field compared to the AMR film.

An MR height (a length between the end of the MR element 13 closer to the air bearing surface 3 and the opposite end) is one factor for determining the reproducing output. The MR height has the following characteristics. The shorter MR height increases the reproducing output, whereas, on the contrary, too short an MR height reduces the reproducing output due to a rise in temperature of the MR element 13 and also reduces the longevity of the MR element 13. The MR height is therefore reduced to such an extent that the reproducing output and the MR element 13 are not adversely affected by the rise in temperature. The thickness of the MR element 13 is tens of nanometers, for example. The length of the MR element 13 in the direction parallel to the air bearing surface 3 is shorter than that of the first shield film 11, the first shield gap film 12, the second shield gap film 14 and the second shield film 15.

A pair of electrode films 16 is electrically connected to the MR element 13. A pair of electrode films 16 is located so that the electrode films 16 may face each other across the MR element 13 in the direction parallel to the air bearing surface 3. Each of the electrode films 16 is formed between the first and second shield gap films 12 and 14, similarly to the MR element 13. For example, each electrode film 16 has a thickness of about tens of nanometers to hundreds of nanometers and has the laminated structure including a permanent magnet film and a conductive film. For example, the permanent magnet film is made of the alloy (CoPt alloy) of cobalt (Co) and platinum (Pt), and the conductive film is made of tantalum (Ta).

Each of lead electrode films 17 is electrically connected to each of the electrode films 16 on the side opposite to the air bearing surface 3 (see FIG. 2). Each of the lead electrode films 17 extends from each electrode film 16 toward the side opposite to the air bearing surface 3. Each lead electrode film 17 is formed between the first and second shield gap films 12 and 14, similarly to each electrode film 16. For example, each lead electrode film 17 is about 50-100 nm in thickness and is made of copper (Cu).

The recording head 20 has the laminated structure including a recording gap 21, a photoresist 22, a thin film coil 23, a photoresist 24, a thin film coil 25, a photoresist 26 and a second magnetic pole 27, these being laminated in order on the second shield film (first magnetic pole) 15. For example, the recording gap 21 is about 0.1-0.3 μm in thickness and is made of the insulating material such as aluminum oxide. The recording gap 21 has an opening 21a near the center of the thin film coils 23 and 25, so that the second shield film 15 is brought into contact with the second magnetic pole 27 and thus the second shield film 15 is magnetically coupled to the second magnetic pole 27.

The photoresist 22 is used for determining a throat height and has a thickness of about 1.0-5.0 μm, for instance. The photoresist 22 is spaced slightly away from the air bearing surface 3 so that the second magnetic pole 27 is in contact with the recording gap 21 near the air bearing surface 3. The photoresist 22 has a similar opening 22a at the position corresponding to the opening 21a of the recording gap 21 so that the second shield film 15 is brought into contact with the second magnetic pole 27. Each of the thin film coils 23 and 25 is about 3 μm in thickness, for example. Each of the thin film coils 23 and 25 is located at the position corresponding to the photoresist 22. The photoresists 24 and 26 are used for ensuring the insulating properties of the thin film coils 23 and 25. The photoresists 24 and 26 are formed at the positions corresponding to the thin film coils 23 and 25, respectively.

For example, the second magnetic pole 27 is about 3 μm in thickness and is made of the magnetic material such as the NiFe alloy or nitride ferrous (FeN). The second magnetic pole 27 extends from the air bearing surface 3 to near the center of the thin film coils 23 and 25. The second magnetic pole 27 is in contact with the recording gap 21 near the air bearing surface 3. The second magnetic pole 27 is also in contact with the second shield film 15 near the center of the thin film coils 23 and 25, and thus the second magnetic pole 27 is magnetically coupled to the second shield film 15.

On the air bearing surface 3, the second magnetic pole 27, the recording gap 21 and the second shield film 15 form a so-called trim structure. This structure is effective in preventing an increase in an effective track width resulting from a spread of magnetic flux which is generated at the time of writing of data on a narrow track.

An over coat layer 4 is formed on the recording head 20 on the side opposite to the reproducing head 10 (the upper portion in FIGS. 1A and 1B) so that the surface may be covered over with the over coat layer 4. For example, the thickness of the over coat layer 4 is 20-30 μm and is made of the insulating material such as aluminum oxide. The over coat layer 4 is not shown in FIG. 2.

The thin film magnetic head having such a constitution can be manufactured in the following manner.

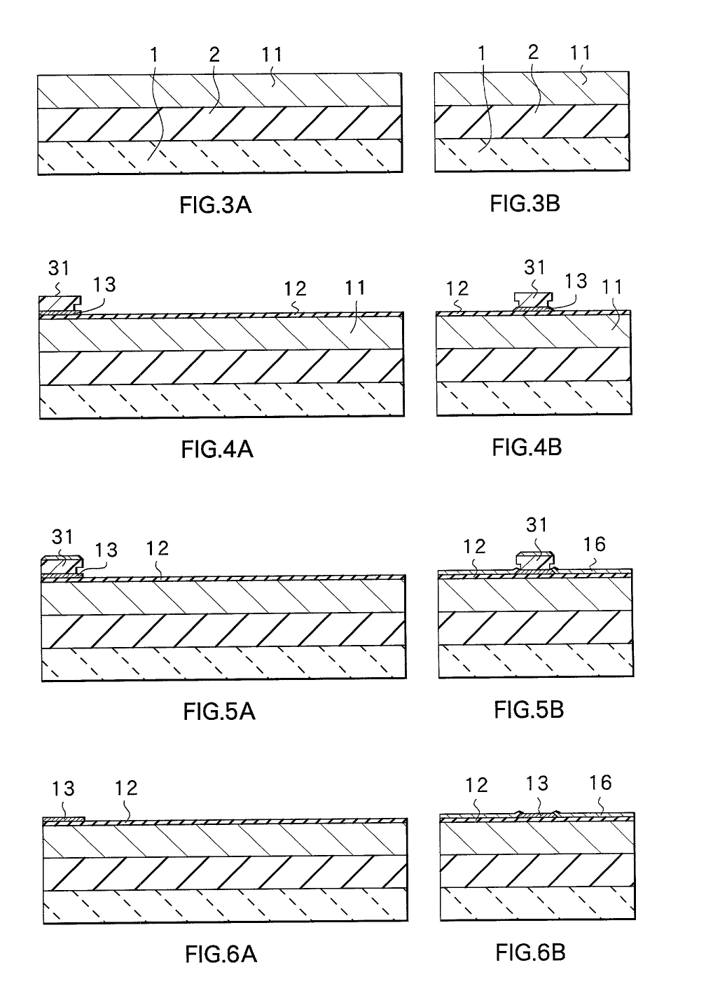

FIGS. 3A to 9B show the processes of manufacturing the thin film magnetic head. FIGS. 3A, 4A, 5A, 6A, 7A, 8A and 9A show a cross section taken on line A-A′ of FIG. 2 perpendicular to the air bearing surface 3. FIGS. 3B, 4B, 5B, 6B, 7B, 8B and 9B show a cross section taken on line B-B′ of FIG. 2 parallel to the air bearing surface 3 of the magnetic pole portion.

First, as shown in FIGS. 3A and 3B, the insulating film 2 made of the insulating material such as aluminum oxide is formed by sputtering on the substrate 1 made of the composite material containing aluminum oxide and titanium carbide, for example. Then, the first shield film 11 made of the magnetic material such as the NiFe alloy is selectively formed on the insulating film 2 by sputtering, for example.

Then, as shown in FIGS. 4A and 4B, the first shield gap film 12 is formed on the first shield film 11 by the aluminum-oxide-containing highly insulative film whose insulating properties are improved by heating. Specifically, for example, an aluminum oxide film containing aluminum oxide is deposited by sputtering or ion beam sputtering, and then the highly insulative film having the improved insulating properties is obtained by heating the aluminum oxide film, whereby the first shield gap film 12 is formed. Moreover, the first shield gap film 12 may be formed in the following manner. For example, the aluminum-oxide-containing highly insulative film having the improved insulating properties is deposited by sputtering or ion beam sputtering while heating the substrate 1, whereby the first shield gap film 12 is formed. Moreover, the first shield gap film 12 may be also formed in the following manner. For example, the aluminum oxide film is deposited by sputtering or ion beam sputtering while heating the substrate 1, and then the highly insulative film is formed by heating the aluminum oxide film, whereby the first shield gap film 12 is formed. This heating allows the reduction in the pinhole density and the increase in the dielectric breakdown field.

In this case, aluminum is used as a target, and oxygen gas (02) and argon gas (Ar) are supplied to an apparatus so as to produce an oxygen-containing atmosphere. Preferably, the heating temperature is within a range of from 150° C. to 450° C. inclusive. More preferably, the heating temperature is within a range of from 200° C. to 350° C. inclusive. Most preferably, the heating temperature is within a range of from 250° C. to 300° C. inclusive. Such a temperature range is set because the low temperature cannot obtain a full effect and the high temperature causes the micro-cracking in the highly insulative film. Preferably, heating takes place for 1 to 5 hours.

After the first shield gap film 12 is formed, as similarly shown in FIGS. 4A and 4B, an MR effect film for forming the MR element 13 is formed on the first shield gap film 12 by sputtering, for example. After the MR film is formed, a photoresist pattern 31 is selectively formed on the MR film at the position at which the MR element 13 is to be formed. At this time, the photoresist pattern 31 having a shape capable of facilitating lift-off, e.g., a T-shaped cross section is formed. Then, the MR film is etched by, for example, ion milling by using the photoresist pattern 31 as a mask, whereby the MR element 13 is formed.

After the MR element 13 is formed, as shown in FIGS. 5A and 5B, the electrode films 16 are selectively formed on the first shield gap film 12 by, for example, sputtering by using the photoresist pattern 31 as the mask. Each of the electrode films 16 is formed by laminating the permanent magnet film made of the CoPt alloy and the conductive film made of tantalum, for example.

After the electrode films 16 are formed, the photoresist pattern 31 is lifted off as shown in FIGS. 6A and 6B. Then, although not shown in these drawings, the lead electrode films 17 made of copper are selectively formed on the first shield gap film 12 by sputtering, for example.

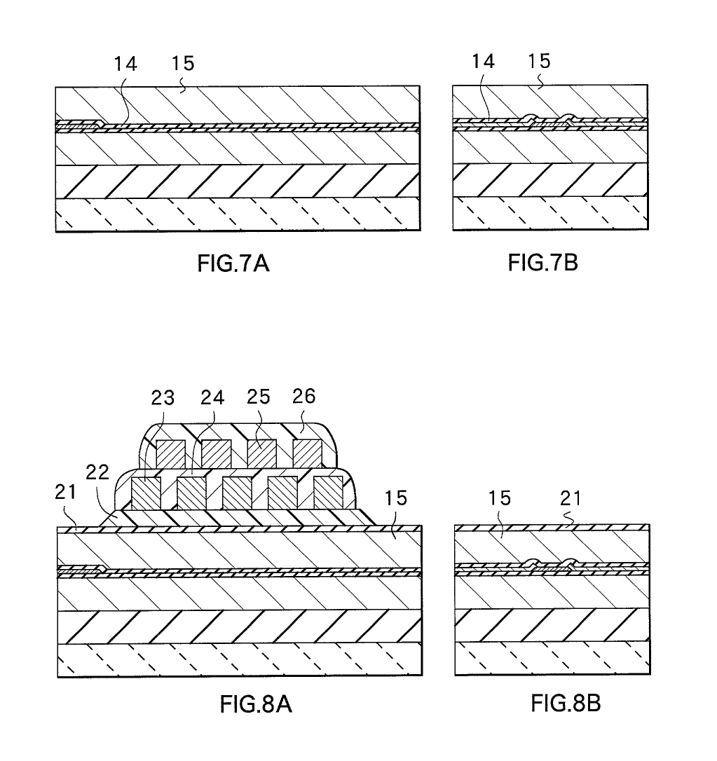

After the lead electrode films 17 are formed, as shown in FIGS. 7A and 7B, the second shield gap film 14 is formed on the first shield gap film 12, the MR element 13, the electrode films 16 and the lead electrode films 17 in the same manner as the first shield gap film 12. Then, the second shield film 15 made of the magnetic material such as the NiFe alloy or nitride ferrous is selectively formed on the second shield gap film 14 by sputtering, for example.

After the second shield film 15 is formed, as shown in FIGS. 8A and 8B, the recording gap 21 made of the insulating material such as aluminum oxide is formed on the second shield film 15 by sputtering, for example. Then, the photoresist 22 is selectively formed on the recording gap 21 by using lithography technology. Then, the thin film coil 23 is selectively formed on the photoresist 22 by plating or sputtering, for example. Then, the photoresist 24 is selectively formed on the photoresist 22 and the thin film coil 23 in the same manner as the photoresist 22. Then, the thin film coil 25 is selectively formed on the photoresist 24 in the same manner as the thin film coil 23. Furthermore, the photoresist 26 is selectively formed on the photoresist 24 and the thin film coil 25 in the same manner as the photoresist 22.

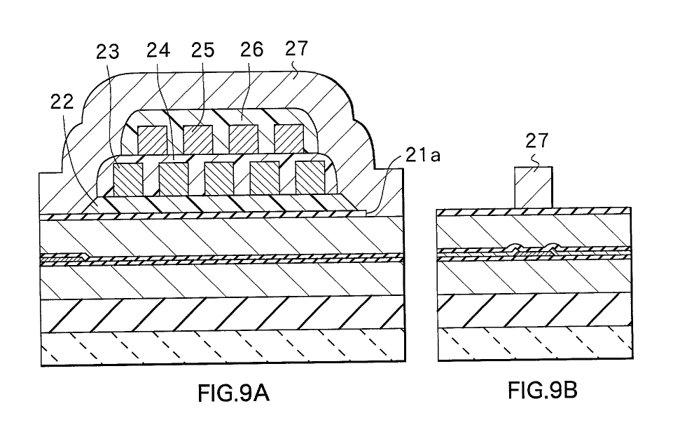

After the photoresist 26 is formed, as shown in FIGS. 9A and 9B, the recording gap 21 is partially etched, whereby the opening 21a is formed near the center of the thin film coils 23 and 25. Then, the second magnetic pole 27 made of the magnetic material such as the NiFe alloy or nitride ferrous is selectively formed on the recording gap 21 and the photoresists 22, 24 and 26 by sputtering, for example.

After the second magnetic pole 27 is formed, the recording gap 21 and the second shield film 15 are partially etched by, for example, ion milling by using the second magnetic pole 27 as the mask. Then, the over coat layer 4 made of aluminum oxide is formed on the second magnetic pole 27 by sputtering, for example. Finally, the air bearing surface 3 of the recording head 20 and the reproducing head 10 is formed by slider machining. Here, the first and second shield gap films 12 and 14 are made of the insulating film containing aluminum nitride and argon, whereby the films 12 and 14 have high hardness and thus the films 12 and 14 are prevented from being excessively ground during machining. The thin film magnetic head shown in FIGS. 1A and 1B is thus completed.

The thin film magnetic head thus manufactured functions in the following manner.

In this thin film magnetic head, the magnetic flux for writing is generated by passing a current through the thin film coils 23 and 25 of the recording head 20, whereby the information is recorded on the magnetic recording medium not shown. The magnetic flux leaking from the magnetic recording medium not shown is detected by passing a sense current through the MR element 13 of the reproducing head 10, whereby the information recorded on the magnetic recording medium not shown is read.

In this case, the electrical insulation between the first and second shield films 11 and 15 and the MR element 13 is provided by the first and second shield gap films 12 and 14. Since each of the first and second shield gap films 12 and 14 is made of the highly insulative film whose insulating properties are improved by heating, the high insulating properties can be ensured even if the film thickness is thin.

According to this embodiment, since each of the first and second shield gap films 12 and 14 is composed of the highly insulative film whose insulating properties are improved by heating, the electrical insulation between the first and second shield films 11 and 15 and the MR element 13 can be ensured even if the film thickness is as thin as 50 nm or less. Therefore, the film thickness of each of the first and second shield gap films 12 and 14 can be reduced to 50 nm or less, and thus a shield gap length can be reduced. Accordingly, the thin film magnetic head of this embodiment can adapt to the increase in a recording density of the magnetic recording medium not shown, can improve quality and can also improve manufacturing yield.

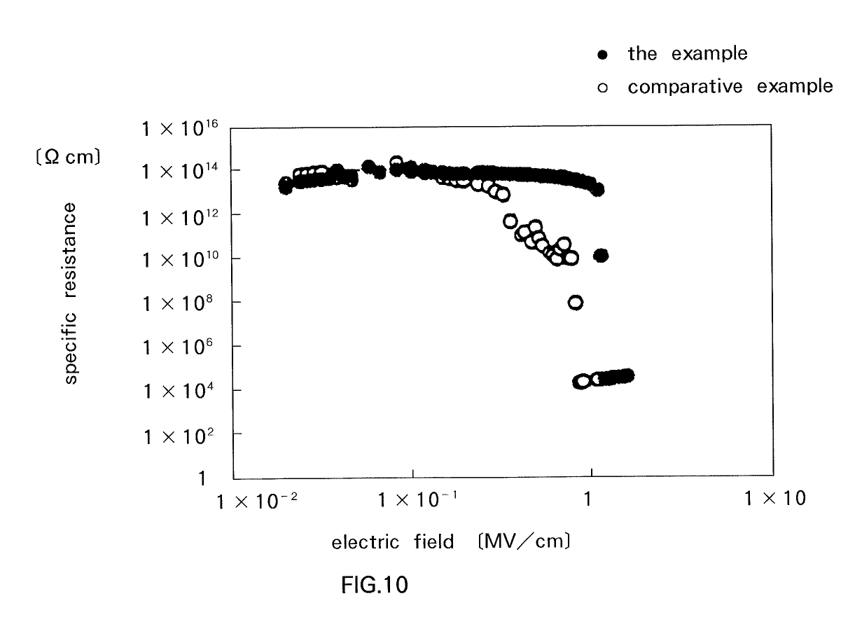

The following experiment was carried out in order to check the effect of this embodiment. First, an NiFe alloy film of 200 nm thick was formed on a test substrate by sputtering. An aluminum oxide film of 20 nm thick was formed on the NiFe alloy film by sputtering in the same manner. The aluminum oxide film was heated for 1 hour at 250° C. in a vacuum. Then, an electrode film made of gold having a diameter of 0.4 mm and a thickness of 200 nm was formed on the aluminum oxide film. A sample of this experiment example was thus obtained. Then, insulation resistance of the sample thus obtained was measured when a voltage was applied between the NiFe alloy film and the electrode film. The result of measurement is shown in FIG. 10.

As Comparison, the sample was prepared in the same manner as the experiment example except that heating in a vacuum did not take place, and the insulation resistance was measured in the same manner as the experiment example. The result of measurement is also shown in FIG. 10.

As is apparent from FIG. 10, according to this example, it is seen that the dielectric breakdown field is improved. In other words, it was seen that the insulating properties of the aluminum oxide film can be improved by heating. It was therefore seen that each of the first and second shield gap films 12 and 14 is made of the highly insulative film having the insulating properties improved by heating, whereby the electrical insulation between the first and second shield films 11 and 15 and the MR element 13 can be ensured by the thin film thickness.

Furthermore, the following experiment was performed in order to check the effect of this embodiment. First, an NiFe alloy film of 200 nm thick was formed on a test substrate by sputtering. An aluminum oxide film of 20 nm thick was formed on the NiFe alloy film by sputtering in the same manner. However, the test substrate was heated at 250° C. at the time of forming of the aluminum oxide film. Then, an electrode film made of gold having a diameter of 0.4 mm and a thickness of 200 nm was formed on the aluminum oxide film. A sample of this experiment example was thus obtained. Then, the insulation resistance of the sample thus obtained was measured when the voltage was applied between the NiFe alloy film and the electrode film.

As a result, although not shown in particular, also according to this example, the improvement in the dielectric breakdown field was seen. That is, it was seen that the insulating properties of the aluminum oxide film can be improved by either of heating after deposition and depositing while heating.

[Second Embodiment]

The thin film magnetic head according to this embodiment has the same constitution, function and effect as the thin film magnetic head according to the first embodiment has, except that each of the first and second shield gap films 12 and 14 comprises a highly thermally conductive insulating film as well as the highly insulative film. Moreover, the thin film magnetic head of this embodiment can be formed in the same manner as the first embodiment. Therefore, the same elements as the elements of the first embodiment are indicated by the same reference numerals, and the detailed description of the same elements is omitted by referring to FIGS. 1A and 1B.

The highly thermally conductive insulating film contains at least one of aluminum nitride (AlN), boron nitride (BN), silicon nitride (Si₃N₄), silicon carbide (SiC) and carbon nitride, for example. These are the insulating material having high thermal conductivity. Thus, the highly thermally conductive insulating film can efficiently transfer and dissipate heat generated in the MR element 13. The highly thermally conductive insulating film may be formed closer to the MR element 13 than the highly insulative film or may be formed on the side opposite to the MR element 13. Moreover, each of the first and second shield gap films 12 and 14 may comprise the highly thermally conductive insulating film made of a plurality of different materials as well as the highly insulative film.

The highly thermally conductive insulating film can be formed by sputtering, for instance. For example, to form the highly thermally conductive insulating film made of aluminum nitride, aluminum is used as the target and nitrogen gas (N₂) and argon gas are supplied to the apparatus so as to produce a nitrogen-containing atmosphere. To form the highly thermally conductive insulating film made of silicon nitride, silicon is used as the target and nitrogen gas and argon gas are supplied to the apparatus so as to produce the nitrogen-containing atmosphere. To form the highly thermally conductive insulating film made of silicon carbide, silicon carbide is used as the target and methane gas (CH₄) and argon gas are supplied to the apparatus. To form the highly thermally conductive insulating film made of boron nitride, boron nitride is used as the target and nitrogen gas and argon gas are supplied to the apparatus. To form the highly thermally conductive insulating film made of carbon nitride, carbon is used as the target and nitrogen gas and argon gas are supplied to the apparatus so as to produce the nitrogen-containing atmosphere.

In the thin film magnetic head having such a constitution, Joule heat is generated by passing the sense current through the MR element 13. Here, since each of the first and second shield gap films 12 and 14 has the highly thermally conductive insulating film, the generated Joule heat can be efficiently transferred to and dissipated into the first and second shield films 11 and 15. Accordingly, the rise in temperature of the MR element 13 is prevented, the reproducing output is increased, and the longevity is extended.

According to this embodiment, each of the first and second shield gap films 12 and 14 comprises the highly thermally conductive insulating film. Thus, the thermal conductivity of the films 12 and 14 can be improved, and therefore the heat generated in the MR element 13 can be efficiently transferred to and dissipated into the first and second shield films 11 and 15 through the first and second shield gap films 12 and 14. Accordingly, the rise in temperature of the MR element 13 can be prevented, the reproducing output can be increased, and the longevity can be extended.

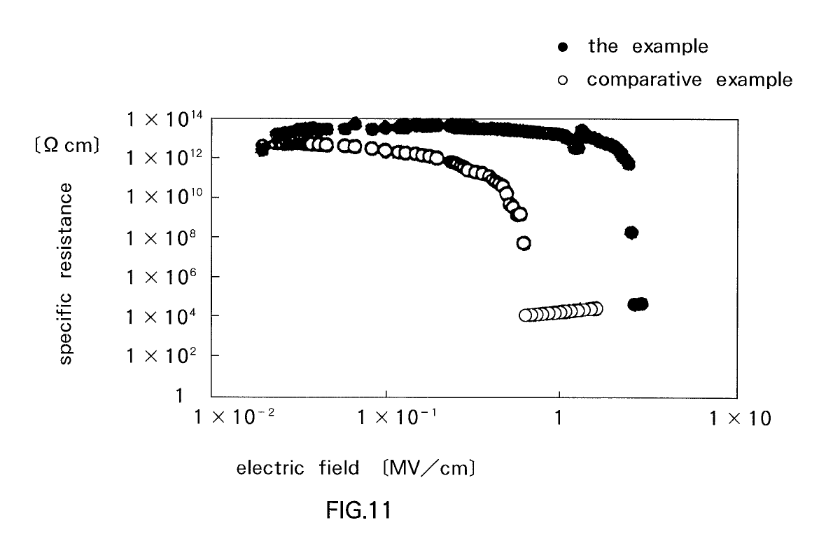

The following experiment was performed in order to check that the thin film magnetic head according to this embodiment can also obtain the high insulating properties similarly to the first embodiment. First, an NiFe alloy film of 200 nm thick was formed on a test substrate by sputtering. An aluminum nitride film of 20 nm thick and an aluminum oxide film of 20 nm thick were laminated on the NiFe alloy film by sputtering in the same manner. The aluminum oxide film was heated for 1 hour at 250° C. in a vacuum. Then, an electrode film made of gold having a diameter of 0.4 mm and a thickness of 200 nm was formed on the aluminum oxide film. A sample of this experiment example was thus obtained. Then, the insulation resistance of the sample thus obtained was measured when the voltage was applied between the NiFe alloy film and the electrode film. The result of measurement is shown in FIG. 11.

As Comparison, the sample was prepared in the same manner as this example except that heating in a vacuum did not take place, and the insulation resistance was measured in the same manner as this example. The result of measurement is also shown in FIG. 11.

As is clear from FIG. 11, according to this example, it is seen that the dielectric breakdown field is improved. That is, also according to this embodiment, it was seen that the electrical insulation between the first and second shield films 11 and 15 and the MR element 13 can be ensured by the thin film thickness.

Furthermore, the following experiment was performed in order to check the effect of this embodiment. First, an NiFe alloy film of 200 nm thick was formed on a test substrate by sputtering. An aluminum nitride film of 20 nm thick and an aluminum oxide film of 20 nm thick were laminated on the NiFe alloy film by sputtering in the same manner. However, the test substrate was heated at 250° C. at the time of forming of the aluminum oxide film. Then, an electrode film made of gold having a diameter of 0.4 mm and a thickness of 200 nm was formed on the aluminum oxide film. A sample of this experiment example was thus obtained. Then, the insulation resistance of the sample thus obtained was measured when the voltage was applied between the NiFe alloy film and the electrode film.

Consequently, although not shown in particular, also according to this example, the improvement in the dielectric breakdown field was seen. That is, it was seen that the insulating properties of the aluminum oxide film can be improved by either of heating after deposition and depositing while heating.

[Third Embodiment]

The thin film magnetic head according to this embodiment has the same constitution, function and effect as the thin film magnetic head according to the first embodiment has, except that each of the first and second shield gap films 12 and 14 comprises the highly insulative film whose insulating properties are improved by treatment in an oxygen-plasma-containing atmosphere or oxygen-ion-containing atmosphere instead of heat treatment. Moreover, the thin film magnetic head of this embodiment can be formed in the same manner as the first embodiment. Therefore, the same elements as the elements of the first embodiment are indicated by the same reference numerals, and the detailed description of the same elements is omitted by referring to FIGS. 1A and 1B.

The highly insulative film contains aluminum oxide and has the insulating properties improved by exposing the film to the oxygen-plasma-containing atmosphere or the oxygen-ion-containing atmosphere after deposition.

The highly insulative film is formed in the following way. For example, the aluminum oxide film is formed by sputtering or ion beam sputtering, and then the surface of the aluminum oxide film is exposed to the oxygen-plasma-containing atmosphere or the oxygen-ion-containing atmosphere, whereby the highly insulative film is formed. Specifically, after the aluminum oxide film is deposited, oxygen gas is introduced into the apparatus, oxygen plasma is generated by applying a high-frequency power to the substrate 1, and the surface is exposed to the oxygen plasma atmosphere. Moreover, after the aluminum oxide film is deposited, the surface of the aluminum oxide film is irradiated with oxygen ion beams.

The following experiment was carried out in order to check the effect of this embodiment. First, an NiFe alloy film of 200 nm thick was formed on a test substrate by sputtering. An aluminum oxide film of 20 nm thick was formed on the NiFe alloy film by sputtering in the same manner. Then, the surface of the aluminum oxide film is exposed to the oxygen plasma atmosphere. Then, an electrode film made of gold having a diameter of 0.4 mm and a thickness of 200 nm was formed on the aluminum oxide film. A sample of this experiment example was thus obtained. Then, the insulation resistance of the sample thus obtained was measured when the voltage was applied between the NiFe alloy film and the electrode film.

Consequently, although not shown in particular, according to this example, the improvement in the dielectric breakdown field was seen. That is, it was seen that the insulating properties of the aluminum oxide film can be improved by exposing the film to the oxygen plasma atmosphere. It was therefore seen that each of the first and second shield gap films 12 and 14 comprises the highly insulative film having the insulating properties improved by the treatment in the oxygen plasma atmosphere, whereby the electrical insulation between the first and second shield films 11 and 15 and the MR element 13 can be ensured by the thin film thickness.

Although not specifically described, the same result was also obtained by irradiating the aluminum oxide film with the oxygen ion beams after depositing the aluminum oxide film.

[Fourth Embodiment]

The thin film magnetic head according to this embodiment has the same constitution, function and effect as the thin film magnetic head according to the second embodiment has, except that similarly to the third embodiment each of the first and second shield gap films 12 and 14 comprises the highly insulative film whose insulating properties are improved by the treatment in the oxygen-plasma-containing atmosphere or oxygen-ion-containing atmosphere instead of heat treatment. Moreover, the thin film magnetic head of this embodiment can be formed in the same manner as the second embodiment. Therefore, the same elements as the elements of the second embodiment are indicated by the same reference numerals, and the detailed description of the same elements is omitted by referring to FIGS. 1A and 1B.

Similarly to the third embodiment, the highly insulative film contains aluminum oxide and has the insulating properties improved by exposing the film to the oxygen-plasma-containing atmosphere or the oxygen-ion-containing atmosphere after deposition.

The highly insulative film is formed in the same manner as the third embodiment. For example, the aluminum oxide film is formed by sputtering or ion beam sputtering, and then the surface of the aluminum oxide film is exposed to the oxygen-plasma-containing atmosphere or the oxygen-ion-containing atmosphere, whereby the highly insulative film is formed.

The following experiment was carried out in order to check the effect of this embodiment. First, an NiFe alloy film of 200 nm thick was formed on a test substrate by sputtering. An aluminum nitride film of 20 nm thick and an aluminum oxide film of 20 nm thick were formed on the NiFe alloy film by sputtering in the same manner. Then, the surface of the aluminum oxide film is exposed to the oxygen plasma atmosphere. Then, an electrode film made of gold having a diameter of 0.4 mm and a thickness of 200 nm was formed on the aluminum oxide film. A sample of this experiment example was thus obtained. Then, the insulation resistance of the sample thus obtained was measured when the voltage was applied between the NiFe alloy film and the electrode film.

Consequently, although not shown in particular, according to this example, the improvement in the dielectric breakdown field was seen. That is, also according to this embodiment, it was seen that the electrical insulation between the first and second shield films 11 and 15 and the MR element 13 can be ensured by the thin film thickness.

Although not specifically described, the same result was also obtained by irradiating the aluminum oxide film with the oxygen ion beams after depositing the aluminum oxide film.

Although the invention has been described above by referring to the embodiments and examples, the invention is not limited to the above-mentioned embodiments and examples and various modifications are possible. For example, in the above-mentioned embodiments, the first and second shield gap films 12 and 14 have been described as the insulating film including the highly insulative film having the improved insulating properties or the insulating film including the highly insulative film and the highly thermally conductive insulating film. However, the insulating film 2, the recording gap 21, the photoresists 22, 24 and 26 or the over coat layer 4 may also comprise the above-described insulating film.

Moreover, although the invention is applied to the thin film magnetic head in the above-described embodiments, the invention is widely applied to a thin film device including the insulating film. The invention is particularly effective in the case where it is necessary to reduce the film thickness and to ensure the high insulating properties.

Furthermore, although the magnetoresistive element of the invention is applied to the thin film magnetic head in the above-described embodiments, the invention is also applicable to the magnetoresistive element at least partly having the insulating film, such as an MR sensor for detecting an acceleration.

Additionally, in the above-mentioned embodiments, the thin film magnetic head has the structure including the reproducing head 10 formed closer to the substrate 1 and the recording head 20 laminated on the reproducing head 10. However, the thin film magnetic head may have the structure including the recording head formed closer to the substrate 1 and the reproducing head laminated on the recording head.

As described above, according to a thin film device of the invention, the insulating film has the highly insulative film whose insulating properties are improved by heating. Thus, the high insulating properties can be ensured even if the thickness of the insulating film is reduced. The following effect is therefore achieved. The thickness of the thin film device can be reduced, and high quality can be ensured.

According to the thin film device of another aspect of the invention, the insulating film further has the highly thermally conductive insulating film. Thus, the thermal conductivity of the insulating film can be increased. The following effect is therefore achieved. The heat generated in the thin film device can be efficiently dissipated, and thus the rise in temperature of the thin film device can be prevented.

Moreover, according to the thin film device of another aspect of the invention, the insulating film has the highly insulative film whose insulating properties are improved by treatment in the oxygen-plasma-containing atmosphere or oxygen-ion-containing atmosphere. Thus, the high insulating properties can be ensured even if the thickness of the insulating film is reduced. The following effect is therefore achieved. The thickness of the thin film device can be reduced, and the high quality can be ensured.

According to the thin film device of another aspect of the invention, the insulating film further has the highly thermally conductive insulating film. Thus, the thermal conductivity of the insulating film can be increased similarly to the above-described thin film device. The following effect is therefore achieved. The rise in temperature of the thin film device can be prevented.

Furthermore, according to a thin film magnetic head of the invention, at least either the first or second shield gap film has the highly insulative film whose insulating properties are improved by heating. Thus, the high insulating properties can be ensured even if the thickness of at least either the first or second shield gap film is reduced. The following effect is therefore achieved. The shield gap length can be reduced, and thus it is possible to adapt to the increase in the recording density of the recording medium. Moreover, the quality can be improved, and the manufacturing yield can be also improved.

According to the thin film magnetic head of another aspect of the invention, at least either the first or second shield gap film further has the highly thermally conductive insulating film. Thus, the thermal conductivity of at least either the first or second shield gap film can be increased. Consequently, the heat generated in the magnetoresistive element can be efficiently dissipated. The following effect is therefore achieved. The rise in temperature of the magnetoresistive element can be prevented, the reproducing output can be increased, and the longevity can be extended.

In addition, according to the thin film magnetic head of another aspect of the invention, at least either the first or second shield gap film has the highly insulative film whose insulating properties are improved by treatment in the oxygen-plasma-containing atmosphere or oxygen-ion-containing atmosphere. Thus, the high insulating properties can be ensured even if the thickness of at least either the first or second shield gap film is reduced. The following effect is therefore achieved similarly to the above-described thin film magnetic head. The shield gap length can be reduced, and thus it is possible to adapt to the increase in the recording density of the recording medium. Moreover, the quality can be improved, and the manufacturing yield can be also improved.

According to the thin film magnetic head of another aspect of the invention, at least either the first or second shield gap film further has the highly thermally conductive insulating film. Thus, the thermal conductivity of at least either the first or second shield gap film can be increased similarly to the above-described thin film magnetic head. The following effect is therefore achieved. The rise in temperature of the magnetoresistive element can be prevented.

Furthermore, according to a magnetoresistive element of the invention, the insulating film has the highly insulative film whose insulating properties are improved by heating. Thus, the high insulating properties can be ensured even if the thickness of the insulating film is reduced. The effect that the high quality can be ensured is therefore achieved.

According to the magnetoresistive element of another aspect of the invention, the insulating film further has the highly thermally conductive insulating film. Thus, the thermal conductivity of the insulating film can be increased. The following effect is therefore achieved. The heat generated in the magnetoresistive element can be efficiently dissipated, and thus the rise in temperature of the magnetoresistive element can be prevented.

Additionally, according to the magnetoresistive element of another aspect of the invention, the insulating film has the highly insulative film whose insulating properties are improved by treatment in the oxygen-plasma-containing atmosphere or oxygen-ion-containing atmosphere. Thus, the high insulating properties can be ensured even if the thickness of the insulating film is reduced. The effect that the high quality can be ensured is therefore achieved.

According to the magnetoresistive element of another aspect of the another aspect of the invention, the insulating film further has the highly thermally conductive insulating film. Thus, the thermal conductivity of the insulating film can be increased similarly to the above-described magnetoresistive element. The following effect is therefore achieved. The rise in temperature of the magnetoresistive element can be prevented.

Furthermore, according to a method of manufacturing a thin film device, a method of manufacturing a thin film magnetic head or a method of manufacturing a magnetoresistive element of the invention, a highly insulative film whose insulating properties are improved by heating is formed. Thus, the thin film device, the thin film magnetic head or the magnetoresistive element of the invention can be easily manufactured. The following effect is therefore achieved. The thin film device, the thin film magnetic head or the magnetoresistive element of the invention can be easily made feasible.

Additionally, according to another method of manufacturing a thin film device, another method of manufacturing a thin film magnetic head or another method of manufacturing a magnetoresistive element of the invention, a highly insulative film whose insulating properties are improved by treatment in an oxygen-plasma-containing atmosphere or oxygen-ion-containing atmosphere is formed. Thus, the thin film device, the thin film magnetic head or the magnetoresistive element of the invention can be easily manufactured. The following effect is therefore achieved. The thin film device, the thin film magnetic head or the magnetoresistive element of the invention can be easily made feasible.

Obviously many modifications and variations of the present invention are possible in the light of the above teachings. It is therefore to be understood that within the scope of the appended claims the invention may be practiced otherwise than as specifically described.

What is claimed is:

1. A thin film device including an insulating film, wherein the insulating film has a highly insulative film containing aluminum oxide and having insulating properties improved by heating.

2. A thin film device according to claim 1, wherein the highly insulative film has the insulating properties improved by heating after deposition.

3. A thin film device according to claim 1 or 2, wherein the highly insulative film has the insulating properties improved by depositing while heating.

4. A thin film device according to claim 1, wherein the highly insulative film is the film heated within a range of from 150° C. to 450° C. inclusive.

5. A thin film device according to claim 1, wherein the highly insulative film is the film heated within a range of from 200° C. to 350° C. inclusive.

6. A thin film device according to claim 1, wherein the highly insulative film is the film heated within a range of from 250° C. to 300° C. inclusive.

7. A thin film device according to claim 1, wherein the insulating film further has a highly thermally conductive insulating film containing at least one of aluminum nitride, boron nitride, silicon nitride, silicon carbide and carbon nitride.

8. A thin film device including an insulating film, wherein the insulating film has a highly insulative film containing aluminum oxide and having insulating properties improved by treatment in an oxygen-plasma-containing atmosphere or oxygen-ion-containing atmosphere.

9. A thin film device according to claim 8, wherein the insulating film further has a highly thermally conductive insulating film containing at least one of aluminum nitride, boron nitride, silicon nitride, silicon carbide and carbon nitride.

10. A thin film magnetic head including a magnetoresistive element, first and second shield films located so as to face each other across the magnetoresistive element and shielding the magnetoresistive element, a first shield gap film located between the first shield film and the magnetoresistive element, and a second shield gap film located between the second shield film and the magnetoresistive element,
wherein at least either the first or second shield gap film has a highly insulative film containing aluminum oxide and having insulating properties improved by heating.

11. A thin film magnetic head according to claim 10, wherein the highly insulative film has the insulating properties improved by heating after deposition.

12. A thin film magnetic head according to claim 10 or 11, wherein the highly insulative film has the insulating properties improved by depositing while heating.

13. A thin film magnetic head according to claim 10, wherein the highly insulative film is the film heated within a range of from 150° C. to 450° C. inclusive.

14. A thin film magnetic head according to claim 10, wherein the highly insulative film is the film heated within a range of from 200° C. to 350° C. inclusive.

15. A thin film magnetic head according to claim 10, wherein the highly insulative film is the film heated within a range of from 250° C. to 300° C. inclusive.

16. A thin film magnetic head according to claim 10, wherein at least either the first or second shield gap film further has a highly thermally conductive insulating film containing at least one of aluminum nitride, boron nitride, silicon nitride, silicon carbide and carbon nitride.

17. A thin film magnetic head according to claim 10, wherein at least either the first or second shield gap film is 50 nm or less in thickness.

18. A thin film magnetic head including a magnetoresistive element, first and second shield films located so as to face each other across the magnetoresistive element and shielding the magnetoresistive element, a first shield gap film located between the first shield film and the magnetoresistive element, and a second shield gap film located between the second shield film and the magnetoresistive element,
wherein at least either the first or second shield gap film has a highly insulative film containing aluminum oxide and having insulating properties improved by treatment in an oxygen-plasma-containing atmosphere or oxygen-ion-containing atmosphere.

19. A thin film magnetic head according to claim 18, wherein at least either the first or second shield gap film further has a highly thermally conductive insulating film containing at least one of aluminum nitride, boron nitride, silicon nitride, silicon carbide and carbon nitride.

20. A thin film magnetic head according to claim 18, wherein at least either the first or second shield gap film is 50 nm or less in thickness.

21. A magnetoresistive element at least partly having an insulating film, wherein the insulating film has a highly insulative film containing aluminum oxide and having insulating properties improved by heating.

22. A magnetoresistive element according to claim 21, wherein the highly insulative film has the insulating properties improved by heating after deposition.

23. A magnetoresistive element according to claim 21 or 22, wherein the highly insulative film has the insulating properties improved by depositing while heating.

24. A magnetoresistive element according to claim 21, wherein the insulating film further has a highly thermally conductive insulating film containing at least one of aluminum nitride, boron nitride, silicon nitride, silicon carbide and carbon nitride.

25. A magnetoresistive element at least partly having an insulating film, wherein the insulating film has a highly insulative film containing aluminum oxide and having insulating properties improved by treatment in an oxygen-plasma-containing atmosphere or oxygen-ion-containing atmosphere.

26. A magnetoresistive element according to claim 25, wherein the insulating film further has a highly thermally conductive insulating film containing at least one of aluminum nitride, boron nitride, silicon nitride, silicon carbide and carbon nitride.

27. A method of manufacturing a thin film device including an insulating film, wherein at least part of the insulating film is formed by an aluminum-oxide-containing highly insulative film whose insulating properties are improved by heating.

28. A method of manufacturing a thin film device according to claim 27, wherein the highly insulative film having the improved insulating properties is formed by heating after deposition.

29. A method of manufacturing a thin film device according to claim 27 or 28, wherein the highly insulative film having the improved insulating properties is formed by depositing while heating.

30. A method of manufacturing a thin film device according to claim 27, wherein the highly insulative film having the improved insulating properties is formed by heating within a range of from 150° C. to 450° C. inclusive.

31. A method of manufacturing a thin film device according to claim 27, wherein the highly insulative film having the improved insulating properties is formed by heating within a range of from 200° C. to 350° C. inclusive.

32. A method of manufacturing a thin film device according to claim 27, wherein the highly insulative film having the improved insulating properties is formed by heating within a range of from 250° C. to 300° C. inclusive.

33. A method of manufacturing a thin film device according to claim 27, wherein a part of the insulating film is further formed by a highly thermally conductive insulating film containing at least one of aluminum nitride, boron nitride, silicon nitride, silicon carbide and carbon nitride.

34. A method of manufacturing a thin film device including an insulating film, wherein at least part of the insulating film is formed by an aluminum-oxide-containing highly insulative film whose insulating properties are improved by treatment in an oxygen-plasma-containing atmosphere or oxygen-ion-containing atmosphere.

35. A method of manufacturing a thin film device according to claim 34, wherein a part of the insulating film is further formed by a highly thermally conductive insulating film containing at least one of aluminum nitride, boron nitride, silicon nitride, silicon carbide and carbon nitride.

36. A method of manufacturing a thin film magnetic head, including the step of laminating in order a first shield film, a first shield gap film, a magnetoresistive element, a second shield gap film and a second shield film,
wherein at least part of at least either the first or second shield gap film is formed by an aluminum-oxide-containing highly insulative film whose insulating properties are improved by heating.

37. A method of manufacturing a thin film magnetic head according to claim 36, wherein the highly insulative film having the improved insulating properties is formed by heating after deposition.

38. A method of manufacturing a thin film magnetic head according to claim 36 or 37, wherein the highly insulative film having the improved insulating properties is formed by depositing while heating.

39. A method of manufacturing a thin film magnetic head according to claim 36, wherein the highly insulative film having the improved insulating properties is formed by heating within a range of from 150° C. to 450° C. inclusive.

40. A method of manufacturing a thin film magnetic head according to claim 36, wherein the highly insulative film having the improved insulating properties is formed by heating within a range of from 200° C. to 350° C. inclusive.

41. A method of manufacturing a thin film magnetic head according to claim 36, wherein the highly insulative film having the improved insulating properties is formed by heating within a range of from 250° C. to 300° C. inclusive.

42. A method of manufacturing a thin film magnetic head according to claim 36, wherein a part of at least either the first or second shield gap film is further formed by a highly thermally conductive insulating film containing at least one of aluminum nitride, boron nitride, silicon nitride, silicon carbide and carbon nitride.

43. A method of manufacturing a thin film magnetic head, including the step of laminating in order a first shield film, a first shield gap film, a magnetoresistive element, a second shield gap film and a second shield film,
wherein at least part of at least either the first or second shield gap film is formed by an aluminum-oxide-containing highly insulative film whose insulating properties are improved by treatment in an oxygen-plasma-containing atmosphere or oxygen-ion-containing atmosphere.

44. A method of manufacturing a thin film magnetic head according to claim 43, wherein a part of at least either the first or second shield gap film is further formed by a highly thermally conductive insulating film containing at least one of aluminum nitride, boron nitride, silicon nitride, silicon carbide and carbon nitride.

45. A method of manufacturing a magnetoresistive element at least partly having an insulating film,
wherein at least part of the insulating film is formed by an aluminum-oxide-containing highly insulative film whose insulating properties are improved by heating.

46. A method of manufacturing a magnetoresistive element according to claim 45, wherein the highly insulative film having the improved insulating properties is formed by heating after deposition.

47. A method of manufacturing a magnetoresistive element according to claim 45, wherein the highly insulative film having the improved insulating properties is formed by depositing while heating.

48. A method of manufacturing a magnetoresistive element according to claim 45, wherein a part of the insulating film is further formed by a highly thermally conductive insulating film containing at least one of aluminum nitride, boron nitride, silicon nitride, silicon carbide and carbon nitride.

49. A method of manufacturing a magnetoresistive element at least partly having an insulating film,
wherein at least part of the insulating film is formed by an aluminum-oxide-containing highly insulative film whose insulating properties are improved by treatment in an oxygen-plasma-containing atmosphere or oxygen-ion-containing atmosphere.

50. A method of manufacturing a magnetoresistive element according to claim 49, wherein a part of the insulating film is further formed by a highly thermally conductive insulating film containing at least one of aluminum nitride, boron nitride, silicon nitride, silicon carbide and carbon nitride.
